(19) United States
(12) Patent Application Publication
(10) Pub. No.: US 2025/0374018 A1
(43) Pub. Date: Dec. 4, 2025

(54) RECEPTION-BASED BROADCAST TEMPLATE ADJUSTMENT

(71) Applicant: GOOGLE LLC, Mountain View, CA (US)

(72) Inventor: Peter T. Liu, Mountain View, CA (US)

(21) Appl. No.: 18/679,657

(22) Filed: May 31, 2024

(51) Int. Cl. H04W 4/80; H04H 20/71

(52) U.S. Cl. CPC H04W 4/80; H04H 20/71

(57) ABSTRACT

A system to broadcast an audio signal includes user equipment (UE) configured to concurrently broadcast the audio signal to a plurality of receiving devices based on a broadcast template. As the UE broadcasts the audio signal, the UE receives reception data from the plurality of receiving devices indicating the quality of the reception of the audio signal. Based on one or more event triggers occurring, the UE adjusts one or more broadcast parameters of the broadcast template based on the reception data received from the plurality of receiving devices. The UE then continues to broadcast the audio signal based on the adjusted broadcast parameters of the broadcast template.

### BACKGROUND

To concurrently provide an audio signal to two or more devices such as earbuds, headphones, speakers, and the like, some user equipment (UE) is configured to broadcast a series of packets to these devices using one or more unidirectional channels. For example, the UE is configured to first packetize the audio signal into a sequence of packets. The UE then broadcasts each packet of the sequence of packets on a unidirectional channel using wireless communication protocols such that the packets are concurrently received by the devices.

Because the channels used to broadcast the packets are unidirectional, the UE is unable to receive acknowledgements that the packets are received by the devices. As such, to help ensure that the sequence of packets is received by each of the devices, the UE also rebroadcasts each packet of the sequence of packets a number of times based on one or more broadcast parameters. These broadcast parameters are often set so as to help ensure the sequence of packets is received by each of the devices even when the devices are in conditions that include high levels of interference, obstructions, or both. However, when the devices are in conditions with lower levels of interference or obstructions, the likelihood is increased that the UE rebroadcasts the packets more times than is necessary to ensure their reception by the devices. Due to the UE rebroadcasting the packets more times than is necessary to ensure their reception by the devices, the airtime is unnecessarily occupied and could be used for other wireless interactions. Furthermore, the amount of energy consumed by the UE is increased, more rapidly draining the battery of the UE, and negatively impacting user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a user equipment (UE) broadcast framework configured for reception-based broadcast template adjustment, in accordance with some embodiments.

FIG. 2 is a block diagram of an example UE configured for broadcast template adjustment based on reception data from receiving devices, in accordance with some embodiments.

FIG. 3 is a diagram an example operation for broadcast template adjustment based on reception data from receiving devices, in accordance with embodiments.

FIG. 4 is a sequence diagram of an example operation for determining a report group, in accordance with embodiments.

FIG. 5 is a sequence diagram of an example operation for requesting reception data from a report group using advertisement signals, in accordance with some embodiments.

FIG. 6 is a sequence diagram of an example operation for requesting reception data from a report group using report requests, in accordance with some embodiments

FIG. 7 is a block diagram of an example UE broadcast framework including a connected device configured for reception-based broadcast template adjustment, in accordance with some embodiments.

FIG. 8 is a block diagram of an example UE broadcast framework including one or more servers configured for reception-based broadcast template adjustment, in accordance with embodiments.

FIG. 9 is a flow diagram of an example method for adjusting a broadcast template based on reception data from one or more receiving devices, in accordance with some embodiments.

### DETAILED DESCRIPTION

Some user equipment (UE) (e.g., one or more compute-enabled phones, tablet computers, personal computers, laptop computers, compute-enabled wearable devices, Internet of Things (IoT) devices, routers, mobile hotspot devices, automotive devices, manufacturing devices) is configured to concurrently broadcast an audio signal to one or more receiving devices using one or more communication protocols, for example, Bluetooth® Low Energy (Bluetooth LE). An audio signal, for example, includes data representing audio to be concurrently output by the receiving devices. These receiving devices include, for example, portable devices having one or more output devices (e.g., speakers) such as wireless headphones, wireless earbuds, wireless in-ear monitors, wireless over-ear headphones, wireless on-ear headphones, bone-conduction headphones, wireless speakers, wireless hearing aids, and the like. Based on receiving the audio signal, each receiving device is configured to output at least a portion of the audio indicated in the audio signal.

As such, systems and techniques disclosed herein are directed to reception-based broadcast template adjustment. For example, a UE is configured to broadcast an audio signal to one or more receiving devices based on a broadcast template that includes data indicating parameters such as a number of retransmissions for each packet of the audio signal, the time-separated positions of those retransmissions, which channels to use to broadcast packets of the audio signal, which channels to use to rebroadcast packets of the audio signal, or any combination thereof. Further, the UE includes or is otherwise connected to broadcast adjustment circuitry configured to adjust the broadcast template (e.g., adjust the parameters of the broadcast template) based on reception data received from the receiving devices. To adjust the broadcast template, the broadcast adjustment circuitry is configured to first identify one or more receiving devices within range of the broadcast of the audio signal. For example, the broadcast adjustment circuitry polls or monitors for one or more advertisement signals being broadcast by one or more receiving devices. These advertisement signals, for example, include information associated with a receiving device such as the access address (e.g., an address at which to access a receiving device), a device address, device information (e.g., type of device, related devices, metrics of the device), or any combination thereof of the receiving device. Based on the advertisement signals being received, the broadcast adjustment circuitry then identifies the receiving devices within range of the broadcast of the audio signal.

From the receiving devices identified to be within range, the broadcast adjustment circuitry determines a report group. A report group, for example, includes one or more of the identified receiving devices from which to track reception data. The broadcast adjustment circuitry determines such a report group, for example, based on the types of the receiving devices (e.g., wireless headphones, wireless earbuds, wireless in-ear monitors, wireless over-ear headphones, wireless on-ear headphones, bone-conduction headphones, wireless speakers, wireless hearing aids), one or more metrics of the receiving devices, operating modes of the UE (e.g., power-saving mode, performance mode), metrics of the UE, a random number generator, or any combination thereof. Metrics of a receiving device include, for example, the distance of the receiving device from the UE, the battery level of the receiving device, an operating mode of the receiving device (e.g., power-saving mode, performance mode), settings of the receiving device (e.g., power-saving settings, performance mode settings, audio quality settings), user inputs, or any combination thereof. Metrics of the UE, for example, include a battery level of the UE, temperature of the UE, settings of the UE (e.g., power-saver settings, performance mode settings, audio quality settings), or any combination thereof. As an example, the broadcast adjustment circuitry selects a predetermined number of receiving devices identified to be within range closest to the UE to be in a report group. As another example, the broadcast adjustment circuitry selects a predetermined number of receiving devices identified to be within the range farthest from the UE to be in a report group. As yet another example, the broadcast adjustment circuitry selects a predetermined number of each type of receiving device from the identified receiving devices to be in a report group.

The broadcast adjustment circuitry then tracks reception data from each receiving device in the report group. That is to say, the broadcast adjustment circuitry receives reception data from each receiving device in the report group. Such reception data, for example, indicates a number of packets of the audio signal received by a receiving device, respective acknowledgements of the reception of corresponding packets of the audio signal by a receiving device, representative timestamps for the reception of one or more corresponding packets of the audio signal by a receiving device, or any combination thereof. For example, reception data includes timestamps for the reception of one or more representative packets of the audio signal.

Regarding the reception data, some receiving devices are configured to implement such reception data in the advertising signals broadcast by the receiving device. As an example, based on receiving one or more packets representing the audio signal broadcast by the UE, a receiving device is configured to broadcast an advertisement signal including reception data. To receive the reception data from these receiving devices, the broadcast adjustment circuitry polls or monitors for the advertising signals of the receiving devices in a report group based on one or more report triggers occurring. For example, the broadcast adjustment circuitry polls or monitors for the advertising signals of the report group each time a report trigger occurs. These report triggers include, for example, a predetermined period of time elapsing, the UE changing locations, user inputs, one or more UE metrics (e.g., battery level, temperature) reaching one or more predetermined thresholds, or any combination thereof. Further, other receiving devices are configured to send a report signal indicating reception data to the broadcast adjustment circuitry based on receiving one or more signals from the broadcast adjustment circuitry. As an example, the broadcast adjustment circuitry is configured to send a report request to the receiving devices in a report group based on one or more report triggers occurring (e.g., each time a report trigger occurs). Such a report request, for example, includes data requesting the reception data from a receiving device. In response to receiving a report request, the receiving device then transmits a report signal to the broadcast adjustment circuitry indicating the reception data for the receiving device. After receiving a signal (e.g., advertising signal, report signal) indicating reception data, the broadcast adjustment circuitry then stores the reception data in a memory, in a database (e.g., via a cellular network), or both.

Using the tracked reception data from the receiving devices in a report group, the broadcast adjustment circuitry is configured to adjust the broadcast template based on one or more trigger events occurring. These trigger events, for example, include a predetermined period of time elapsing, the UE changing locations, one or more receiving devices changing locations, the number of packets received by one or more receiving devices being below a threshold number, the number of packets received by one or more receiving devices being above a threshold number, one or more metrics (e.g., battery level, temperature) of the UE, losing contact with (e.g., receiving no signals from in a predetermined amount of time) a receiving device, or any combination thereof, to name a few. Once a trigger event occurs, the broadcast adjustment circuitry, for example, is configured to adjust a broadcast template (e.g., adjust the parameters of the broadcast template) based on the number of packets received by the receiving devices in a report group over a predetermined period of time as indicated by the tracked reception data, the number of packets received by one or more certain receiving devices in a report group over a predetermined period of time as indicated by the tracked reception data, the number of rebroadcasted packets received by the receiving devices in a report group over a predetermined period of time as indicated by the tracked reception data, the number of rebroadcasted packets received by one or more certain receiving devices in a report group over a predetermined period of time as indicated by the tracked reception data, an operating mode (e.g., power-saving mode, performance mode) of the UE, or any combination thereof. As an example, the broadcast adjustment circuitry is configured to, based on the number of rebroadcasted packets received by the receiving devices in a report group over a predetermined period of time, adjust a broadcast template so as to indicate a number of rebroadcasts for each packet that helps ensure one or more certain receiving devices in the report group receive the audio signal. That is to say, for example, the broadcast adjustment circuitry adjusts a broadcast template so as to indicate the minimum number of rebroadcasts for each packet necessary to have the likelihood that one or more certain receiving devices in the report group receive the audio signal be equal to or above a predetermined threshold.

In this way, the broadcast adjustment circuitry is configured to change the broadcast template of the UE based on the reception data of the receiving devices as the conditions of the UE change (e.g., as different trigger events occur). For example, as the location of the UE changes, the broadcast adjustment circuitry is configured to determine a number of rebroadcasts for the packets of the audio signal, the time intervals between transmission of one or more rebroadcasted packets, or both so as to help ensure each receiving device receives the audio signal while limiting power consumption. For example, the broadcast adjustment circuitry is configured to determine the minimum number of rebroadcasts needed for each packet of the audio signal such that the audio signal is likely to be received by each receiving device. By determining the minimum number of rebroadcasts needed for each packet of the audio signal such that the audio signal is likely to be received by each receiving device, the broadcast template circuitry helps to avoid the UE from rebroadcasting packets more than is necessary, which helps lower the power consumption of the UE and conserve airtime for other traffic.

As used herein, the term “circuitry” includes hardwired circuitry, programmable circuitry, or a combination thereof. For example, circuitry may include circuitry of an application-specific integrated circuit (ASIC) that is hardwired or hardcoded to perform corresponding functions, one or more processors that execute software stored in one or more memories or other storage media to perform corresponding functions, programmable logic that has been programmed to perform corresponding functions, or some combination thereof.

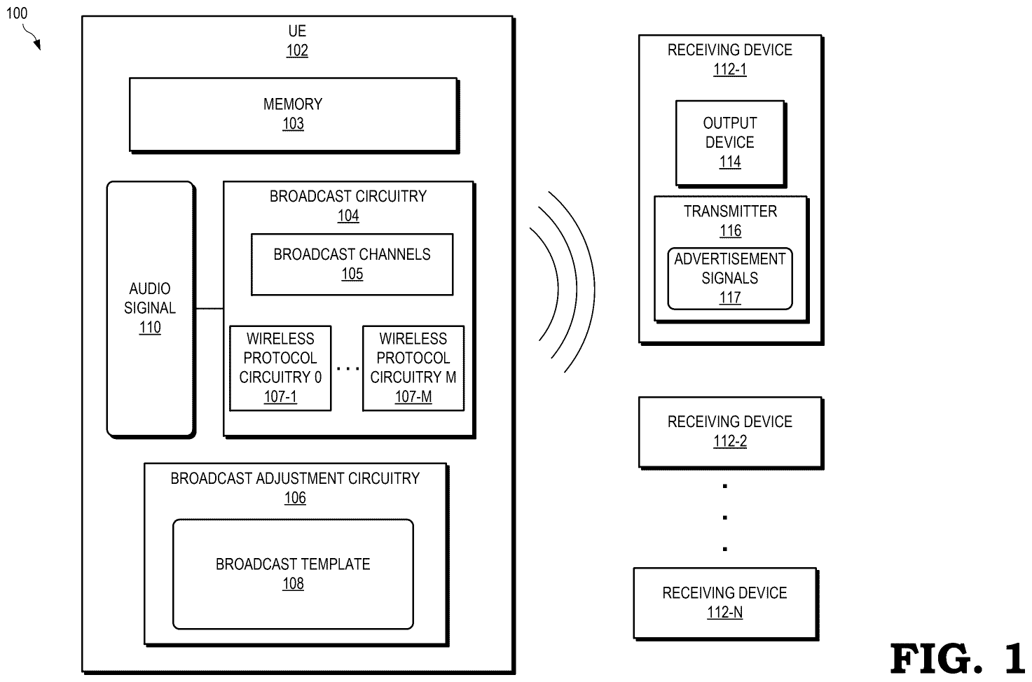

FIG. 1 illustrates a UE broadcast framework 100 configured for reception-based broadcast template adjustment, in accordance with some embodiments. In embodiments, UE broadcast framework 100 includes UE 102 configured to concurrently broadcast an audio signal 110 to one or more receiving devices 112. UE 102 includes, for example, a compute-enabled phone (“smartphone”), tablet computer, personal computer, laptop computer, compute-enabled wearable device (e.g., smartwatch, fitness tracker, smart bracelet), Internet of Things (IoT) device, router, mobile hotspot device, an automotive device, a manufacturing device, or any combination thereof, to name a few. According to some embodiments, UE 102 includes a battery (not shown for clarity) configured to provide power to one or more components (e.g., broadcast circuitry 104, broadcast adjustment circuitry 106, telephony circuitry, memory 103) of UE 102.

In embodiments, UE 102 includes broadcast circuitry 104 configured to concurrently broadcast audio signal 110 to one or more receiving devices 112. Such broadcast circuitry 104, for example, includes one or more transmitters, processors, microprocessors, packetizers, broadcast channels 105, or any combination thereof configured to broadcast one or more signals. Audio signal 110, for example, includes data representing audio to be output by each receiving device 112. A receiving device 112, for example, includes a portable device configured to output audio signal 110, such as wireless headphones, wireless earbuds, wireless in-ear monitors, wireless over-ear headphones, wireless on-ear headphones, bone-conduction headphones, wireless speakers, wireless hearing aids, and the like. To output audio signal 110, each receiving device 112 includes one or more output devices 114 configured to output at least a portion of audio signal 110, for example, speakers, monitors, and the like. Though the example embodiment illustrated in FIG. 1 shows UE 102 concurrently broadcasting audio signal 110 to three receiving devices (112-1, 112-2, 112-N) representing an N number of receiving devices 112, in other embodiments, UE 102 can concurrently broadcast audio signal 110 to any number of receiving devices 112.

To broadcast audio signal 110 concurrently to receiving devices 112, broadcast circuitry 104 is configured to broadcast audio signal 110 based on a broadcast template 108. A broadcast template 108, for example, includes data indicating one or more parameters for broadcasting audio signal 110 such as a predetermined period of time at which to broadcast packets representing audio signal 110, a predetermined number of rebroadcasts for each packet representing audio signal 110, one or more communication protocols to use to broadcast audio signal 110, one or more broadcast channels 105 to use for broadcasting packets, one or more broadcast channels 105 to use for rebroadcasting packets, or any combination thereof. Further, to broadcast audio signal 110 concurrently to receiving devices 112, broadcast circuitry 104 includes one or more broadcast channels 105. These broadcast channels 105 include unidirectional channels configured to wirelessly broadcast data (e.g., audio signal 110) concurrently to one or more receiving devices 112 according to one or more communication protocols such as Bluetooth®, Bluetooth LE protocols, ZigBee® protocols, Z-Wave® protocols, or the like. As an example, in embodiments, broadcast channels 105 include one or more broadcast isochronous channels configured to broadcast data according to Bluetooth LE protocols.

To enable broadcast circuitry 104 to wirelessly broadcast data using one or more communication protocols, broadcast circuitry 104 includes one or more instances of wireless communication protocol circuitry 107 each associated with a corresponding wireless communication protocol (e.g., Bluetooth®, Bluetooth LE, ZigBee®, Z-Wave®). Each instance of wireless communication protocol circuitry 107, for example, includes one or more radios, microcontrollers, and the like configured to transmit and receive wireless signals according to a corresponding communication protocol. For example, a first instance of wireless communication protocol circuitry 107-1 includes one or more radios and microcontrollers configured to transmit and receive wireless signals according to a first wireless communication protocol (e.g., Bluetooth LE protocol) and a second instance (e.g., Mth instance) of wireless communication protocol circuitry 107-M includes one or more radios and microcontrollers configured to transmit and receive wireless signals according to a second wireless communication protocol (e.g., ZigBee® protocol) different from the first set of wireless communication protocols. Though the example embodiment presented in FIG. 1 presents broadcast circuitry 104 as including two instances of wireless communication protocol circuitry (107-1, 107-M) representing an M number of instances of wireless communication protocol circuitry each associated with a corresponding wireless communication protocol, in other embodiments, broadcast circuitry 104 can include any number of instances of wireless communication protocol circuitry each associated with a corresponding wireless communication protocol.

In some embodiments, broadcast circuitry 104 is configured to first packetize audio signal 110 before transmitting audio signal 110 as a series of packets to the receiving devices 112. For example, in embodiments, broadcast circuitry 104 is configured to generate a series of packets each including data (e.g., a payload) representing a respective portion of audio signal 110. Broadcast circuitry 104 then broadcasts each packet of the series of packets representing audio signal 110 to the receiving devices 112. For example, in embodiments, broadcast circuitry 104 broadcasts a respective packet of the series of packets representing audio signal 110 on one or more broadcast channels 105 each time a predetermined amount of time elapses. Based on receiving the packet, a receiving device 112 then outputs the data indicated in the packet (e.g., in the payload of the packet). To help ensure that each receiving device 112 receives each packet of the series of packets representing audio signal 110, broadcast circuitry 104 is configured to rebroadcast each packet of the series of packets a predetermined number of times. That is to say, after broadcasting a first packet of the series of packets representing audio signal 110, broadcast circuitry 104 is configured to again broadcast the first packet a predetermined number of times, over, for example, a predetermined amount of time. In some embodiments, broadcast circuitry 104 is configured to rebroadcast a packet on a different broadcast channel 105 than the broadcast channel 105 used to initially broadcast the packet. As an example, in embodiments, broadcast circuitry 104 is configured to broadcast a first packet on a first isochronous channel and rebroadcast the first packet a predetermined number of times on one or more other isochronous channels different from the first isochronous channel. In embodiments, broadcast circuitry 104 is configured to rebroadcast each packet a number of times each at a corresponding frequency. For example, broadcast circuitry 104 rebroadcasts a first packet a first time at a first frequency on an isochronous channel and rebroadcasts the first packet a second time at a second frequency different from the first frequency on the isochronous channel.

According to embodiments, because broadcast channels 105 are unidirectional channels, broadcast channels 105 cannot receive data transmitted from the receiving devices 112. For example, broadcast channels 105 cannot receive acknowledgements from the receiving devices 112 confirming the reception of a packet. Because broadcast channels 105 cannot receive such acknowledgements, broadcast circuitry 104 rebroadcasts each packet of audio signal a set number of times so as to help ensure that the receiving devices 112 receive the packets in a wide range of conditions. These conditions, for example, include locations with high signal interference (e.g., from other wireless devices), indoor locations with signal obstructions (e.g., walls, physical objects), and the like. However, when the receiving devices 112 are in conditions with lower signal interference or obstructions, broadcast circuitry 104 rebroadcasting the packets of audio signal 110 in this way increases the likelihood that broadcast circuitry 104 rebroadcasts each packet more times than is necessary to help ensure the reception of the packet by the receiving devices 112. As such, in these conditions, broadcast circuitry 104 consumes more airtime bandwidth and battery power than is necessary to help ensure the reception of the packet by the receiving devices 112, preventing the use of airtime for other traffic and more rapidly draining the battery of UE 102 and negatively impacting user experience.

To this end, UE 102 includes or is otherwise connected to broadcast adjustment circuitry 106 configured to adjust broadcast template 108 based on data received from receiving devices 112. That is to say, broadcast adjustment circuitry 106 is configured to adjust one or more parameters used to broadcast audio signal 110 based on feedback from receiving devices 112. In some embodiments, broadcast adjustment circuitry 106 is implemented within UE 102 while in other embodiments broadcast adjustment circuitry 106 is otherwise connected to UE 102 via one or more wireless communication protocols, a network, or both.

According to embodiments, broadcast adjustment circuitry 106 is configured to first identify the receiving devices 112 within range of the broadcast of audio signal 110 based on one or more advertisement signals 117 transmitted by the receiving devices 112. For example, in embodiments, each receiving device 112 includes a transmitter 116 that includes circuitry configured to periodically broadcast an advertisement signal 117. Such an advertisement signal 117, for example, includes device data indicating the access address of the receiving device 112 (e.g., an address at which to access a receiving device 112), a device address of the receiving device 112, device information (e.g., type of device, related devices, metrics of the device) of the receiving device 112, metrics of the receiving device, or any combination thereof. To identify the receiving devices 112 within range of the broadcast of audio signal 110 based on the advertisement signals 117, broadcast adjustment circuitry is 106 is configured to first poll or monitor for one or more advertisement signals 117. Based on receiving an advertisement signal 117 from a receiving device 112, broadcast adjustment circuitry 106 determines that the receiving device 112 is within range of the broadcast of audio signal 110 and also determines the identity (e.g., device identifier, addresses, device type) of the receiving device 112.

After determining the receiving devices 112 in range of the broadcast of audio signal 110, broadcast adjustment circuitry 106 then selects one or more of the identified receiving devices 112 to be in a report group. A report group, for example, includes one or more receiving devices 112 from which to track reception data. In embodiments, broadcast adjustment circuitry 106 is configured to select receiving devices 112 for a report group based on, for example, the types of the receiving devices (e.g., wireless headphones, wireless earbuds, wireless in-ear monitors, wireless over-ear headphones, wireless on-ear headphones, bone-conduction headphones, wireless speakers, wireless hearing aids), one or more metrics of the receiving devices 112, operating modes of UE 102 (e.g., power-saving mode, performance mode), metrics of UE 102, a random number generator, or any combination thereof. Metrics of a receiving device 112 include, for example, the distance of the receiving device 112 from UE 102, the battery level of the receiving device 112, an operating mode of the receiving device 112 (e.g., power-saving mode, performance mode), settings of the receiving device 112 (e.g., power-saving settings, performance mode settings, audio quality settings), user inputs, or any combination thereof. Metrics of UE 102, for example, include a battery level of UE 102, the temperature of UE 102, settings of UE 102 (e.g., power-saving settings, performance mode settings, audio quality settings), or any combination thereof.

As an example, according to embodiments, broadcast adjustment circuitry 106 randomly selects a predetermined number of receiving devices 112 identified to be within range of the broadcast of audio signal 110 to be in a report group. As another example, broadcast adjustment circuitry 106 selects a predetermined number of receiving devices 112 closest to UE 102 to be in a report group. As yet another example, broadcast adjustment circuitry 106 selects a predetermined number of each type of receiving device 112 from the receiving devices 112 identified to be within range of the broadcast of audio signal 110 to be in a report group. In embodiments, another example includes broadcast adjustment circuitry 106 selecting a predetermined number of the receiving devices 112 from the receiving devices 112 identified to be within range of the broadcast of audio signal 110 farthest from UE 102 to be in a report group. According to embodiments, to help determine one or more metrics of UE 102, UE 102 includes one or more sensors configured to take measurements (e.g., acceleration, location, angle, temperature, battery level) of UE 102. Such sensors, for example, include accelerometers, thermometers, humidity sensors, gyroscopes, and the like.

Once broadcast adjustment circuitry 106 has selected one or more receiving devices 112 for a report group, broadcast adjustment circuitry 106 then tracks the reception data of the receiving devices 112 in the report group. The reception data, for example, indicates a number of packets of audio signal 110 received by a receiving device 112, respective acknowledgements of the reception of corresponding packets by a receiving device 112, representative timestamps for the reception of corresponding packets by a receiving device 112, or any combination thereof. To this end, in some embodiments, one or more receiving devices 112 are configured to include reception data in one or more advertisement signals 117 broadcast by the receiving device 112. That is to say, one or more receiving devices 112 are configured to broadcast one or more advertisement signals 117 that include data (e.g., reception data) indicating a number of packets of audio signal 110 received by a receiving device 112, respective acknowledgements of the reception of corresponding packets by a receiving device 112, representative timestamps for the reception of corresponding packets by a receiving device 112, or any combination thereof. As an example, based on receiving one or more packets of audio signal 110, a receiving device 112 is configured to begin broadcasting (e.g., periodically broadcasting) an advertisement signal 117 that includes reception data. In other embodiments, one or more receiving devices 112 are configured to transmit a report signal to broadcast adjustment circuitry 106 that includes the reception data of the receiving device 112. For example, a receiving device 112 is configured to transmit a report signal to broadcast adjustment circuitry 106 based on receiving a signal (e.g., a report request) from broadcast adjustment circuitry 106.

To track the reception data of the receiving devices 112 in a report group, in embodiments, broadcast adjustment circuitry 106 is configured to poll or monitor for one or more advertisement signals 117 (e.g., advertisement signals 117 including reception data) from receiving devices 112 in the report group, send one or more report requests to one or more receiving devices 112 in the report group, wait for regular or intermittent reports from one or more receiving devices 112 in the report group, or any combination of the foregoing based on one or more report triggers occurring. As an example, broadcast adjustment circuitry 106 is configured to poll or monitor for one or more advertisement signals from a report group, send one or more report requests to receiving devices 112 in a report group, wait for regular or intermittent reports from one or more receiving devices 112 in a report group, or any combination of the foregoing each time a trigger event occurs. Such report triggers include, for example, a predetermined amount of time elapsing (e.g., a predetermined amount of time after forming a report group elapsing), UE 102 changing locations, user inputs, one or more UE metrics (e.g., battery level, temperature) reaching one or more predetermined thresholds, or any combination thereof. As an example, broadcast adjustment circuitry 106 is configured to poll or monitor for one or more advertisement signals 117 (e.g., advertisement signals 117 including reception data) from receiving devices 112 in the report group, send one or more report requests to one or more receiving devices 112 in the report group, or both each time a predetermined period of time elapses, or configure select receiving devices 112 to send reports at predetermined intervals. A report request, for example, includes data requesting the reception data from a receiving device 112. After receiving the reception data of a receiving device 112 from polling or monitoring for an advertisement signal 117 of the receiving device 112 or receiving a report signal from the receiving device 112, broadcast adjustment circuitry 106 stores the reception data in a memory 103 included in or otherwise connected to UE 102. In this way, broadcast adjustment circuitry 106 tracks the reception data of the receiving devices 112 in a report group over time and stores the tracked reception data in a memory 103.

According to embodiments, broadcast adjustment circuitry 106 is configured to adjust the broadcast template 108 (e.g., change one or more broadcast parameters) using the tracked reception data (e.g., the reception data of receiving devices 112 in a report group) based on one or more trigger events occurring (e.g., each time a trigger event occurs). These trigger events, for example, include a predetermined amount of time elapsing (e.g., a predetermined amount of time since starting to broadcast audio signal 110, a predetermined amount of time since a previous trigger event occurred), UE 102 changing locations, the number of packets received by one or more receiving devices 112 being below a threshold number (e.g., as indicated by tracked reception data), the number of packets received by one or more receiving devices being above a threshold number (e.g., as indicated by tracked reception data), one or more metrics (e.g., battery level, temperature) of UE 102, losing contact with (e.g., receiving no signals from in a predetermined amount of time) a receiving device 112, or any combination thereof, to name a few. Based on one or more event triggers occurring, broadcast adjustment circuitry 106 is configured to adjust one or more parameters of broadcast template 108 based on the tracked data of the receiving devices 112 in the report group. For example, broadcast adjustment circuitry 106 is configured to adjust one or more parameters of broadcast template 108 based on the number of packets received by the receiving devices 112 in a report group over a predetermined period of time, the number of packets received by one or more certain receiving devices 112 in a report group over a predetermined period of time, the number of rebroadcasted packets received by the receiving devices 112 in a report group over a predetermined period of time, the number of rebroadcasted packets received by one or more certain receiving devices 112, or any combination thereof as indicated by the tracked reception data. As an example, broadcast adjustment circuitry 106 is configured to, based on the number of rebroadcasted packets received by the receiving devices 112 in a report group over a predetermined period of time as indicated by tracked reception data, adjust broadcast template 108 so as to indicate a number of rebroadcasts for each packet that helps ensure one or more certain receiving devices 112 in the report group receive the packets of audio signal 110. That is to say, for example, broadcast adjustment circuitry 106 adjusts broadcast template 108 so as to indicate the minimum number of rebroadcasts for each packet necessary so as to have the likelihood that one or more certain receiving devices 112 in the report group receive audio signal 110 be equal to or above a predetermined threshold.

According to embodiments, broadcast circuitry 104 is also configured to adjust broadcast template 108 based on an operating mode (e.g., low-power mode, performance mode) of UE 102. For example, based on UE 102 being in a power-saving mode, broadcast adjustment circuitry 106 adjusts broadcast template 108 so as to indicate the minimum number of rebroadcasts for each packet necessary so as to have the likelihood that one or more of the receiving devices 112 in the report group closest to UE 102 receive audio signal 110 be equal to or above a predetermined threshold. As another example, based on UE 102 being in a performance mode, broadcast adjustment circuitry 106 adjusts broadcast template 108 so as to indicate the minimum number of rebroadcasts for each packet necessary so as to have the likelihood that one or more of the receiving devices 112 in the report group farthest from UE 102 receive audio signal 110 be equal to or above a predetermined threshold. Additionally, in embodiments, broadcast circuitry 104 is configured to adjust broadcast template 108 by implementing one or more trained machine-learning models, trained neural networks, or both. For example, in some embodiments, broadcast circuitry 104 is configured to train one or more machine learning models, neural networks, or both based on reception data tracked from one or more receiving devices 112. Such trained machine learning models and neural networks, for example, are configured to receive at least a portion of the tracked reception for receiving devices 112 in a report group, the operating mode of UE 102, or both as inputs and output one or more broadcast parameters such as parameters to broadcast packets of the audio signals such as a number of retransmissions for each packets, which frequencies to use to broadcast packets of the audio signals, which channels to use to rebroadcast packets, or any combination thereof, to name a few.

As such, broadcast adjustment circuitry 106 is configured to adjust broadcast template 108 based on the reception data of the receiving devices 112 as different trigger events occur. That is to say, broadcast adjustment circuitry 106 is configured to adjust broadcast template 108 based on the reception data of the receiving devices 112 as conditions (e.g., locations, interferences, obstructions) change. As an example, as the location of UE 102 changes, broadcast adjustment circuitry 106 is configured to determine a number of rebroadcasts for the packets of audio signal 110 so as to help ensure each receiving device 112 receives audio signal 110 in the new location while also limiting power consumption. For example, in embodiments, broadcast adjustment circuitry 106 is configured to determine the minimum number of rebroadcasts needed for each packet of audio signal 110 such that audio signal 110 is likely to be received by each receiving device 112. By determining the minimum number of rebroadcasts needed for each packet of audio signal 110 such that audio signal 110 is likely to be received by each receiving device 112, broadcast adjustment circuitry 106, by modifying one or more parameters of broadcast template 108, helps to avoid broadcast circuitry 104 from rebroadcasting packets more than is necessary, helping to lower the power consumption of broadcast circuitry 104.

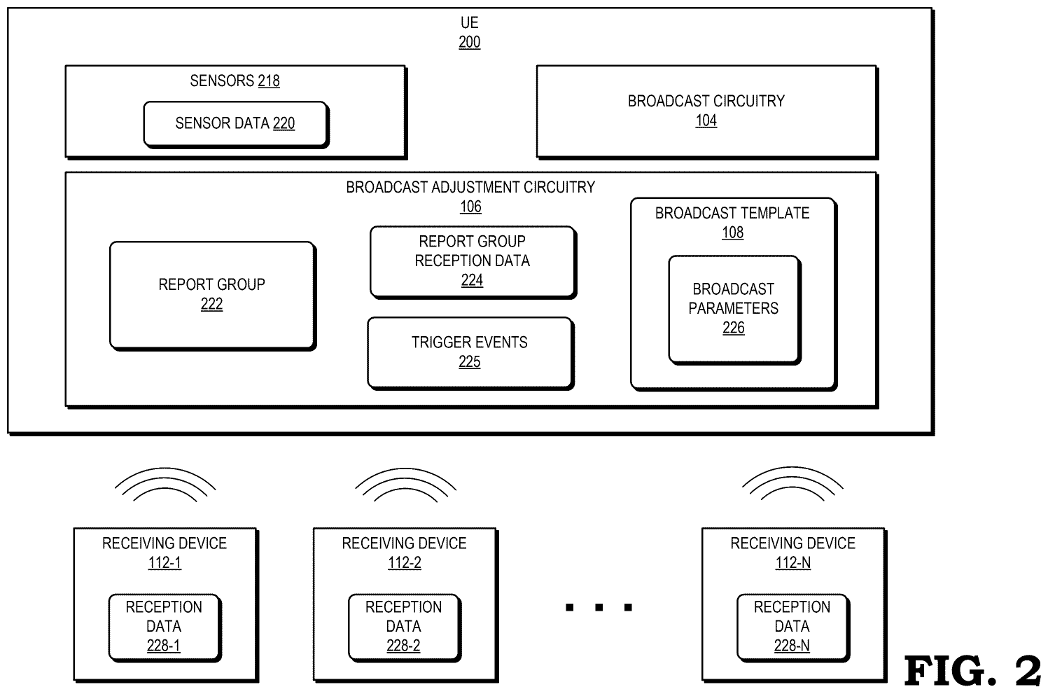

Referring now to FIG. 2, an example UE 200 configured for based broadcast template adjustment is presented, in accordance with some embodiments. According to embodiments, UE 200 is implemented in UE broadcast framework 100 as UE 102. In embodiments, UE 200 is configured to broadcast audio signal 110 to one or more receiving devices 112 using broadcast circuitry 104. For example, broadcast circuitry 104 is configured to first packetize audio signal 110 into a series of packets. Broadcast circuitry 104 then broadcasts and rebroadcasts each packet of the series of packets representing audio signal 110 based on broadcast template 108. Broadcast template 108, for example, includes data indicating one or more broadcast parameters 226 such as a number of retransmissions for each packet of the series of packets, which broadcast channels 105 to use to broadcast packets of series of packets, which broadcast channels 105 to use to rebroadcast packets of the series of packets, or any combination thereof.

To help ensure that each receiving device 112 receives audio signal 110 without excessively draining a battery of UE 200, UE 200 includes broadcast adjustment circuitry 106 configured to adjust one or more broadcast parameters 226 indicated by broadcast template 108 based on the tracked reception data of receiving devices 112 in a report group (e.g., report group reception data 224). To this end, in embodiments, broadcast adjustment circuitry 106 is configured to identify one or more receiving devices 112 within range to receive the broadcast of audio signal 110. For example, broadcast adjustment circuitry 106 first polls or monitors for one or more advertisement signals 117 broadcast by one or more receiving devices 112. Based on the advertisement signals 117, broadcast adjustment circuitry 106 then identifies one or more receiving devices 112 within range of the broadcast of audio signal 110. As an example, in response to receiving an advertisement signal 117, broadcast adjustment circuitry 106 determines the access address of a receiving device 112 (e.g., an address at which to access a receiving device), a device address of the receiving device 112, device information (e.g., type of device, related devices, metrics of the device) of the receiving device 112, or any combination thereof.

After identifying the receiving devices 112 within range to receive the broadcast of audio signal 110, broadcast adjustment circuitry 106 selects one or more of the identified receiving devices 112 to form a report group 222. That is to say, broadcast adjustment circuitry 106 selects one or more of the receiving devices 112 within range to receive the broadcast of audio signal 110 to add to a report group 222. Such a report group 222, for example, includes one or more receiving devices 112 from which to track reception data 228. In embodiments, broadcast adjustment circuitry 106 is configured to select one or more identified receiving devices 112 for a report group 222 based on, for example, the types of the identified receiving devices 112, one or more metrics of the receiving devices 112, operating modes of UE 200 (e.g., power-saving mode, performance mode), metrics of UE 200, a random number generator, or any combination thereof. Metrics of a receiving device 112 include, for example, the distance of the receiving device 112 from UE 200, the battery level of the receiving device 112, an operating mode of the receiving device 112 (e.g., power-saving mode, performance mode), settings of the receiving device 112 (e.g., power-saving settings, performance mode settings, audio quality settings), user inputs, or any combination thereof. Metrics of UE 200, for example, include a battery level of UE 200, temperature of UE 200, settings of UE 200 (e.g., power-saving settings, performance mode settings, audio quality settings), or any combination thereof.

For example, based on UE 200 being in a performance operating mode, broadcast adjustment circuitry 106 is configured to select a predetermined number of the identified receiving devices farthest from the user to be in the report group 222. As another example, based on UE 200 being in a low-power operating mode, broadcast adjustment circuitry 106 is configured to select a predetermined number of the identified receiving devices closest from the user to be in the report group 222. As yet another example, broadcast adjustment circuitry 106 is configured to randomly select a predetermined number of the identified receiving devices to be in the report group 222. According to embodiments, another example includes broadcast adjustment circuitry 106 selecting a predetermined number of identified receiving devices 112 that have a certain type (e.g., earbuds, headphones, hearing aids) to be in the report group 222.

In embodiments, to determine one or more metrics of UE 200, UE 200 includes one or more sensors 218 configured to take one or more measurements of UE 200. For example, one or more sensors 218 are configured to measure the acceleration, angle, movement, location, temperature, battery level, or any combination thereof of UE 200. To this end, sensors 218 include one or more accelerometers, temperature sensors, humidity sensors, gyroscopes, or any combination thereof. Further, according to embodiments, each sensor of sensors 218 is configured to output sensor data 220 representing the one or more measurements taken by the sensor. In some embodiments, UE 200 is configured to store sensor data 220 in a memory (e.g., memory 103) included in or otherwise connected to UE 200.

Once broadcast adjustment circuitry 106 has selected one or more identified receiving devices 112 for the report group 222, broadcast adjustment circuitry 106 tracks reception data 228 of the receiving devices 112 within the report group 222. Reception data 228, for example, indicates a number of packets of audio signal 110 received by a receiving device 112, which rebroadcasts of the audio signal were received by a receiving device 112, respective acknowledgements of the reception of corresponding packets by a receiving device 112, representative timestamps for the reception of corresponding packets by a receiving device 112, metrics of the receiving device 112, or any combination thereof. In some embodiments, one or more receiving devices 112 are configured to provide reception data 228 in one or more advertisement signals 117 broadcast by the receiving device 112. For example, based on receiving one or more packets of audio signal 110, a receiving device 112 is configured to include reception data 228 in the advertisement signals 117 broadcast by the receiving device 112. In some other embodiments, one or more receiving devices 112 are configured to transmit one or more report signals that include reception data 228 to broadcast adjustment circuitry. As an example, in some embodiments, one or more receiving devices 112 are configured to transmit a report signal including reception data 228 based on receiving a report request from broadcast adjustment circuitry 106.

To receive reception data 228 from one or more receiving devices 112 in a report group 222, broadcast adjustment circuitry 106 is configured to poll or monitor for one or more advertisement signals 117 broadcast by one or more receiving devices 112, transmit one or more report requests to one or more receiving devices 112, or both based on a report trigger occurring (e.g., each time a report trigger occurs). These report triggers include, for example, a predetermined amount of time elapsing (e.g., a predetermined amount of time since a report group 222 was formed), UE 200 changing locations, user inputs, one or more UE metrics (e.g., battery level, temperature) reaching one or more predetermined thresholds, or any combination thereof. Such a report request, for example, includes data requesting the reception data 228 from a receiving device. In response to receiving a signal (e.g., advertising signal 117, report signal) indicating the reception data 228 of a receiving device 112, broadcast adjustment circuitry 106 stores the reception data 228 in a memory (e.g., 103) included in otherwise connected to UE 200, a database (e.g., via a network), or both. Such reception data 228 stored in a memory, database, or both is represented in FIG. 2 as report group reception data 224. In this way, broadcast adjustment circuitry 106 is configured to track reception data (e.g., report group reception data 224) of the receiving devices 112 in a report group 222 over a period of time.

Based on report group reception data 224, broadcast adjustment circuitry 106 is configured to adjust one or more broadcast parameters 226 of the broadcast template 108. For example, based on one or more trigger events 225 occurring (e.g., each time a trigger event 225 occurs), broadcast adjustment circuitry 106 is configured to adjust one or more broadcast parameters 226 of the broadcast template 108 using report group reception data 224. These trigger events 225, for example, include a predetermined amount of time elapsing (e.g., a predetermined amount of time since UE 200 began broadcasting audio signal 110, a predetermined amount of time since a previous trigger event 225)), UE 200 changing locations, the number of packets received by one or more receiving devices 112 being below a threshold number (e.g., as indicated by tracked reception data), the number of packets received by one or more receiving devices being above a threshold number (e.g., as indicated by tracked reception data), one or more metrics (e.g., battery level, temperature) of UE 200, losing contact with (e.g., receiving no signals from in a predetermined amount of time) a receiving device 112, or any combination thereof, to name a few. When one or more trigger events 225 occur, broadcast adjustment circuitry 106 then adjusts one or more broadcast parameters 226 of broadcast template 108 based on report group reception data 224. As an example, broadcast adjustment circuitry 106 is configured to adjust one or more broadcast parameters 226 based on the number of packets received by the receiving devices 112 in the report group 222 over a predetermined period of time, the number of packets received by one or more certain receiving devices 112 in the report group 222 over a predetermined period of time, the number of rebroadcasted packets received by the receiving devices 112 in the report group 222 over a predetermined period of time, the number of rebroadcasted packets received by one or more certain receiving devices 112 over a predetermined period of time, or any combination thereof as indicated by report group reception data 224.

In embodiments, broadcast adjustment circuitry 106 is configured to, based on report group reception data 224, adjust one or more broadcast parameters 226 so as to indicate a number of rebroadcasts for each packet that helps ensure one or more certain receiving devices 112 in the report group 222 receive the packets of audio signal 110. That is to say, for example, based on the number of rebroadcasted packets received by the receiving devices 112 in a report group 222 over a predetermined period of time as indicated by report group reception data 224, broadcast adjustment circuitry 106 adjusts one or more broadcast parameters 226 so as to indicate the minimum number of rebroadcasts for each packet necessary so as to have the likelihood that one or more certain receiving devices 112 in the report group 222 receive audio signal 110 be equal to or above a predetermined threshold. According to embodiments, broadcast adjustment circuitry 106 is also configured to adjust one or more broadcast parameters 226 based on an operating mode (e.g., power-saving mode, performance mode) of UE 200. For example, based on UE 102 being in a power-saving mode, broadcast adjustment circuitry 106 adjusts one or more broadcast parameters so as to indicate the minimum number of rebroadcasts for each packet necessary to have the likelihood that one or more of the receiving devices 112 in the report group closest to UE 200 receive audio signal 110 be equal to or above a predetermined threshold. As another example, based on UE 200 being in a performance mode, broadcast adjustment circuitry 106 adjusts one or more broadcast parameters 226 so as to indicate the minimum number of rebroadcasts for each packet necessary to have the likelihood that one or more of the receiving devices 112 in the report group farthest from UE 200 receive audio signal 110 be equal to or above a predetermined threshold.

In some embodiments, broadcast adjustment circuitry 106 is configured to adjust one or more broadcast parameters 226 of broadcast template 108 by implementing one or more trained machine-learning models, trained neural networks, or both. For example, in some embodiments, broadcast adjustment circuitry 106 is configured to train one or more machine learning models, neural networks, or both based on report group reception data 224. Such trained machine-learning models and neural networks, for example, are configured to receive at least a portion of report group reception data 224, the operating mode of UE 200, or both as inputs and output one or more broadcast parameters 226 such as a number of retransmissions for each packets, which broadcast frequencies 105 to use to broadcast packets of audio signal 110, which broadcast frequencies 105 to use to rebroadcast packets of audio signal 110, or any combination thereof, to name a few.

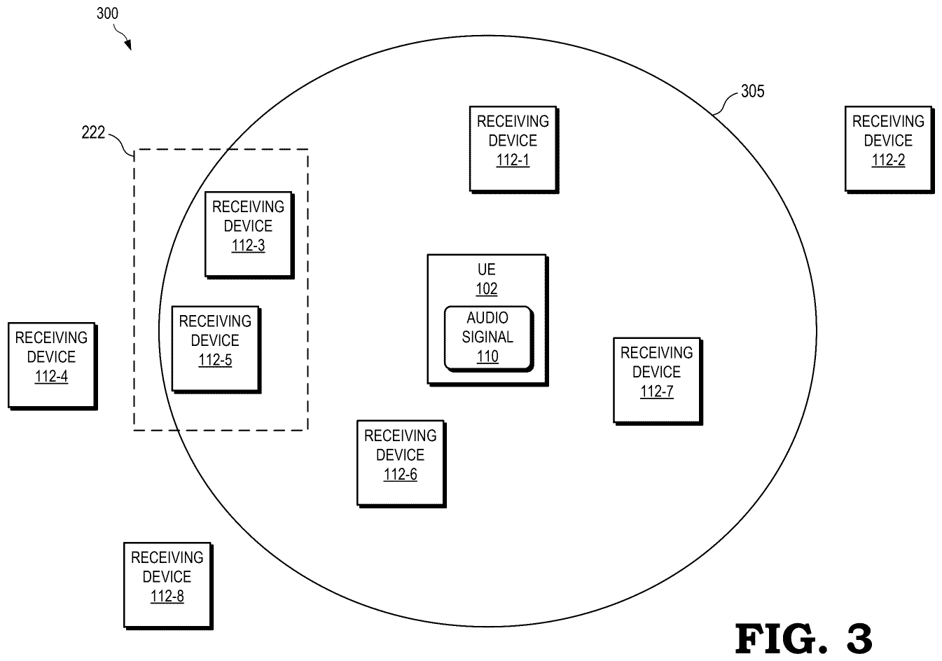

Referring now to FIG. 3, an example operation 300 for broadcast template adjustment based on reception data from receiving devices is presented, in accordance with some embodiments. According to embodiments, example operation 300 is implemented at least in part by UE 102, 200. For example, example operation 300 first includes UE 102 broadcasting audio signal 110 as a series of packets based on a range 305. Such a range 305, for example, represents the distance away from UE 102 at which receiving devices 112 are able to receive the broadcast of audio signal 110, UE 102 is able to receive signals from a receiving device 112, or both. That is to say, the distance away from UE 102 at which receiving devices 112 are able to receive a predetermined percentage of the broadcast series of packets representing audio signal 110, UE 102 is able to receive signals (e.g., advertisement signals 117) from the receiving devices 112, or both. In embodiments, range 305, for example, is based on the communication protocols (e.g., Bluetooth LE) used to broadcast audio signal 110. Referring to the example embodiment presented in FIG. 3, the range 305 at which UE 102 is configured to broadcast audio signal 110 is represented as circle. However, in other embodiments, the range 305 at which UE 102 is configured to broadcast audio signal 110 can include any two-dimensional or three-dimensional shape.

Referring to the example embodiment presented in FIG. 3, example operation 300 includes five receiving devices (112-1, 112-3, 112-5, 112-6, 112-7) within range 305 that are enabled to receive at least a portion of the broadcast series of packets representing audio signal 110. Further, the example embodiment presented in FIG. 3 shows three receiving device (112-2, 112-4, 112-8) outside of range 305 such that these receiving devices are unable to receive the broadcast series of packets representing audio signal 110. Though the example embodiment presented in FIG. 3 shows five receiving devices within range 305 and three devices outside of range 305, in other embodiments, any number of receiving devices 112 can be inside of range 305 and any number of receiving devices 112 can be outside of range 305. In embodiments, based on the receiving devices 112 within range 305, UE 102 is configured to determine a report group 222. As an example, UE 102 first determines which receiving devices 112 are within range 305 by monitoring for one or more advertisement signals 117 broadcast by the receiving devices 112. Based on receiving an advertisement signal 117 from a receiving device 112, UE 102 determines that the receiving device 112 is within range 305. As another example, UE 102 monitors for advertisement signals 117 including reception data 228 associated with the broadcast of audio signal 110. Based on received advertisement signal 117 including such reception data 228, UE 102 determines that the corresponding receiving device 112 is within range 305. Referring to the example embodiment presented in FIG. 3, UE 102 determines that receiving devices 112-1, 112-3, 112-5, 112-6, and 112-7 are within range 305.

After determining which receiving devices 112 are within range 305, UE 102 determines a report group 222 by selecting one or more of the receiving devices 112 within range 305. For example, based on the types of receiving devices 112 within range 305, metrics of the receiving devices 112 within range 305, operating modes of UE 102, metrics of UE 102, a random number generator, or any combination thereof, UE 102 selects one or more receiving devices 112 within range 305 to be in a report group 222. As an example, referring to the embodiment presented in FIG. 3, UE 102 selects receiving devices 112-3 and 112-5 to be in a report group 222. Though the example embodiment presented in FIG. 3 shows UE 102 as selecting two receiving devices 112 to be in a report group 222, in other embodiments, UE 102 can select any number of receiving devices within range 305 to be in report group 222.

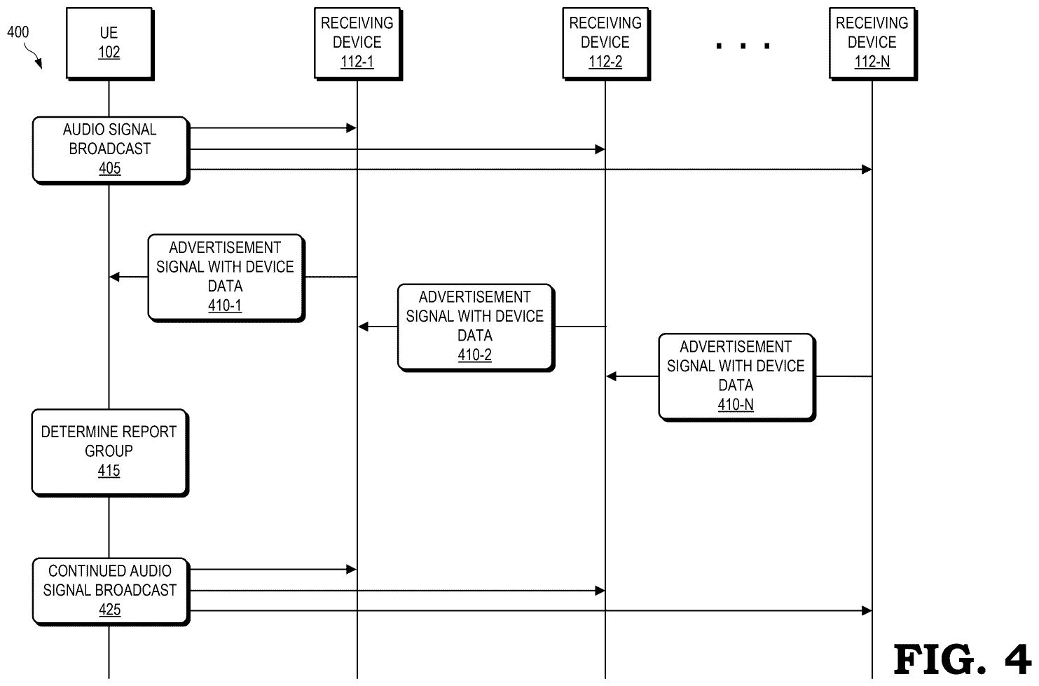

Referring now to FIG. 4, an example operation 400 for determining a report group is presented, in accordance with embodiments. According to embodiments, example operation 400 is implemented, at least in part, by UE 102 and one or more receiving devices 112. Example operation 400 first includes UE 102 performing an audio signal broadcast 405 which includes UE 102 broadcasting a series of packets representing audio signal 110 using one or more communication protocols. Referring to the example embodiment presented in FIG. 4, this series of packets representing audio signal 110 is received by receiving devices 112-1, 112-2, 112-N. Though FIG. 4 shows three receiving devices (112-1, 112-2, 112-N) representing an N integer number of receiving devices (where N>1) receiving the series of packets representing an audio signal 110, in other embodiments, any number of receiving devices 112 within range of UE 102 can receive the series of packets representing an audio signal 110. Concurrently with performing audio signal broadcast 405, UE 102 is configured to determine which receiving devices are in range (e.g., range 305) of UE 102. That is to say, UE 102 is configured to determine which receiving devices 112 are a distance away from UE 102 that allows the receiving devices 112 to receive a predetermined percentage of the broadcast series of packets representing audio signal 110, UE 102 to receive signals from the receiving devices 112, or both. To determine which receiving devices 112 are in range, for example, UE 102 monitors for advertisement signals (e.g., advertisement signals 117) from one or more receiving devices 112. Within example operation 400, UE 102 is configured to monitor for advertisement signals that includes device data (e.g., the access address, a device address, device information, metrics) identifying corresponding receiving devices 112, represented in FIG. 4 as advertisement signals with device data 410. As an example, UE 102 receives a first advertisement signal with device data 410-1 identifying a first receiving device 112-1, a second advertisement signal with device data 410-2 identifying a second receiving device 112-2, and a third (e.g., Nth) advertisement signal with device data 410-N identifying a third (e.g., Nth) receiving device 112-N.

According to embodiments, based on receiving an advertisement signal with device data 410, UE 102 determines that the receiving device 112 identified by the advertisement signal with device data 410 is within range. For example, based on the advertisement signals with device data 410, UE 102 determines that the first receiving device 112-1, the second receiving device 112-2, and the third receiving device 112-N are within range. After identifying which receiving devices 112 are within range and concurrently with audio signal broadcast 405, UE 102 is configured to perform determine report group 415 during which UE 102 selects one or more receiving devices 112 within range to be in a report group 222. As an example, based on the types of receiving devices 112 within range, metrics of the receiving devices 112 within range, operating modes of UE 102, metrics of UE 102, a random number generator, or any combination thereof, UE 102 selects one or more receiving devices 112 within range to be in a report group 222. Referring to the example embodiment presented in FIG. 4, UE 102 selects the first receiving device 112-1, the second receiving device 112-2, and the third receiving device 112-N to be in a report group 222. After UE 102 performs determine report group 415 and forms a report group 222, UE 102 continues to broadcast the series of packets representing audio signal 110, represented in FIG. 4 as continued audio signal broadcast 425.

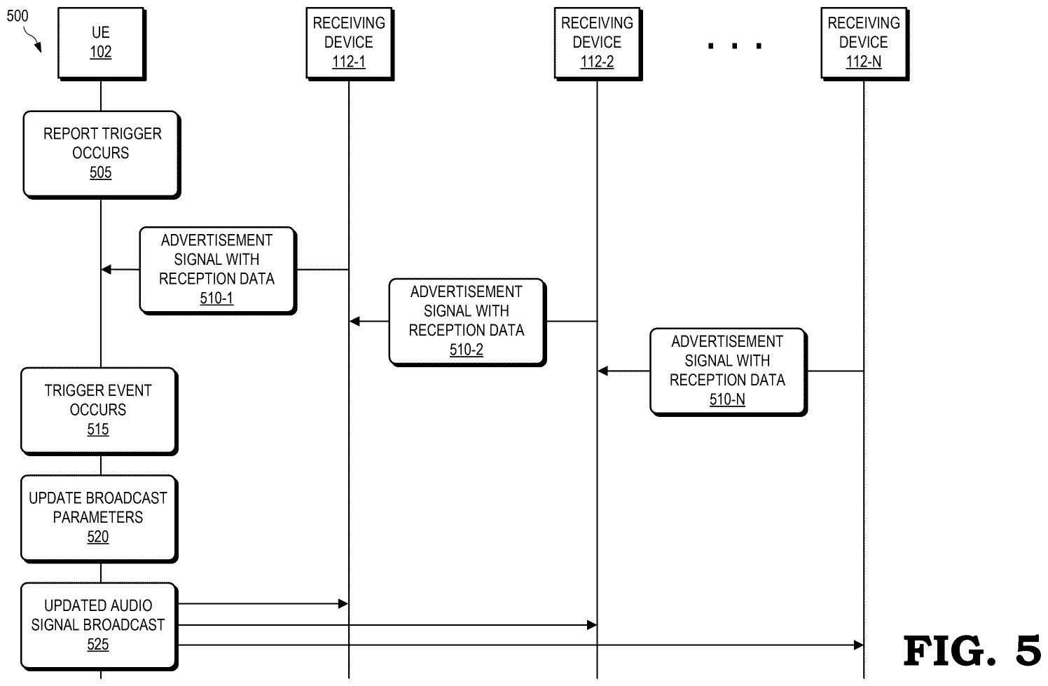

Referring now to FIG. 5, an example operation 500 for requesting reception data from a report group using advertisement signals is presented, in accordance with some embodiments. In embodiments, example operation 500 is implemented at least in part by UE 102 and one or more receiving devices 114 after example operation 400 has been performed. Additionally, according to embodiments, example operation 500 is implemented at least in part by UE 102 concurrently with UE 102 broadcasting audio signal 110 (e.g., performing audio signal broadcast 405). Example operation 500 first includes UE 102 determining that a report trigger occurs 505. As an example, UE 102 determines a report trigger occurs by determining that a predetermined amount of time has elapsed since UE 102 formed a report group 222. Based on determining that a report trigger has occurred, UE 102 monitors or polls for advertisement signals 117 from one or more receiving devices 112 in a report group 222. Referring to the example embodiment presented in FIG. 5, UE 102 monitors or polls for advertisement signals 117 from a report group 222 that includes a first receiving device 112-1, a second receiving device 112-2, and a third (e.g., Nth) receiving device 112-N. According to embodiments, based on receiving one or more packets of the broadcast series of packets representing audio signal 110, a receiving device 112 is configured to start broadcasting (e.g., periodically broadcasting) advertisement signals 117 that include reception data 228. As such, the advertisement signals 117 broadcast by receiving devices 112-1, 112-2, 112-N include reception data 228 and are represented in FIG. 5 as advertisement signal with reception data 510. In this way, based on a trigger event occurring, UE 102 determines the reception data 228 from the report group 222 by polling or monitoring for a first advertisement signal with reception data 510-1 from the first receiving device 112-1, a second advertisement signal with reception data 510-2 from the second receiving device 112-1, and a third advertisement signal with reception data 510-N from the third receiving device 112-N.

Though the example embodiment presented in FIG. 5 shows UE 102 as only polling or monitoring for one advertisement signal with reception data 510 from each receiving device 112 in a report group 222, in other embodiments, UE 102 can poll or monitor for any number of advertisement signals with reception data 510 from each receiving device 112 within a report group 222. For example, UE 102 is configured to poll or monitor for advertisement signals with reception data 510 from a report group 222 each time a report trigger occurs. Additionally, though the example embodiment presented in FIG. 5 shows a report group 222 as including three receiving devices (112-1, 112-2, 112-N) representing an N integer number (where N>1) of receiving devices, in other embodiments, the report group 222 can include any number of receiving devices 112. Within example operation 500, after polling or monitoring for one or more advertisement signals with reception data 510 from the receiving devices 112 within a report group 222, UE 102 determines that a trigger event occurs 515. That is to say, UE 102 determines that one or more trigger events 225 occur such as a predetermined period of time elapsing (e.g., a predetermined period of time since UE 102 began broadcasting audio signal 110), UE 102 changing locations, user inputs, one or more UE metrics reaching one or more predetermined thresholds, or any combination thereof.

After the trigger event occurs 515, UE 102 updates one or more broadcast parameters 226 of the broadcast template 108 used to broadcast audio signal 110. For example, based on the reception data 228 indicated in the advertisement signals with reception data 510 received from the receiving devices 112 in the report group 222, UE 102 modifies one or more broadcast parameters 226 of the broadcast template 108. As an example, based on the reception data 228, UE 102 modifies a broadcast parameter 226 indicating a number of rebroadcasts for each packet of the broadcast series of packets representing audio signal 110 so as to help ensure each receiving device in the report group 222 (e.g., the first receiving device 112-1, the second receiving device 112-2, and the third receiving device 112-N) receives the packets representing audio signal 110. After UE 102 modifies one or more broadcast parameters 226 of the broadcast template 108 used to broadcast audio signal 110, UE 102 begins broadcasting audio signal 110 based on the updated broadcast template 108 (e.g., the broadcast template 108 with one or more modified broadcast parameters 226) represented in FIG. 5 as updated audio signal broadcast 525.

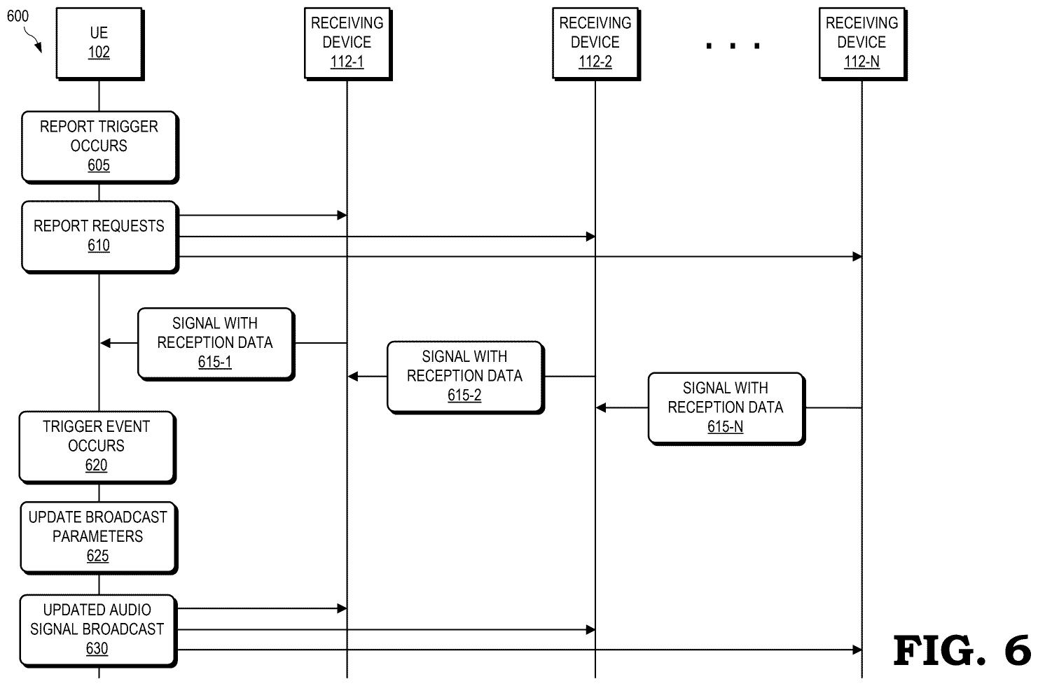

Referring now to FIG. 6, an example operation 600 for requesting reception data from a report group using report requests is presented, in accordance with some embodiments. In embodiments, example operation 600 is implemented at least in part by UE 102 and one or more receiving devices 112 after example operation 400 has been performed. Additionally, according to embodiments, example operation 600 is implemented at least in part by UE 102 concurrently with UE 102 broadcasting audio signal 110 (e.g., performing audio signal broadcast 405). Example operation 600 includes UE 102 first determining that a report trigger occurs 605. As an example, UE 102 determines a report trigger occurs by determining that a predetermined amount of time has elapsed since UE 102 determined a report group 222. Based on determining that a report trigger has occurred, UE 102 then transmits a report request 610 to each receiving device 112 within a report group 222 using one or more communication protocols (e.g., Bluetooth®). Referring to the example embodiment presented in FIG. 6, UE 102 transmits a respective report request 610 to each receiving device in a report group 222 that includes a first receiving device 112-1, a second receiving device 112-2, and a third (e.g., Nth) receiving device 112-N. Such a report request 610, for example, includes data requesting reception data 228 from a corresponding receiving device 112. Though the example embodiment presented in FIG. 6 shows UE 102 transmitting report requests 610 to a report group 222 including three receiving devices (112-1, 112-2, 112-N) representing an N integer number (where N>1) of receiving devices 112, in other embodiments, UE 102 transmits report requests 610 to a report group 222 including any number of receiving devices 112.

Based on receiving a report request 610 from UE 102, each receiving device 112 in the report group 222 is configured to transmit, using one or more communication protocols, a signal including reception data 228 associated with the receiving device 112 to UE 102. These signals including reception data 228 associated with a corresponding receiving device 112 are represented in FIG. 6 as signals with reception data 615. For example, based on receiving respective report requests 610, the first receiving device 112-1 transmits a first signal with reception data 615-1 to UE 102, the second receiving device 112-2 transmits a second signal with reception data 615-2 to UE 102, and the third receiving device 112-N transmit a third (e.g., Nth) signal with reception data 615-N to UE 102. Though the example embodiment presented in FIG. 6 shows UE 102 as only sending one report request 610 to each receiving device 112 in a report group 222 and receiving one signal with reception data 615 from each receiving device 112, in other embodiments, UE 102 is configured to send a report request 610 and receive signals with reception data 615 each time a report trigger occurs. Within example operation 600, after receiving one or more signals with reception data 615 from each receiving device 112 in a report group 222, UE 102 determines that a trigger event occurs 620. That is to say, UE 102 determines that one or more trigger events 225 occur such as a predetermined period of time elapsing (e.g., a predetermined period of time since UE 102 began broadcasting audio signal 110), UE 102 changing locations, user inputs, one or more UE metrics reaching one or more predetermined thresholds, or any combination thereof.

After the trigger event occurs 620, UE 102 then performs update broadcast parameters 625 to update one or more broadcast parameters 226 of the broadcast template 108 used to broadcast audio signal 110. For example, based on the reception data 228 indicated in the signals with reception data 615 received from the receiving devices 112 in the report group 222, UE 102 modifies one or more broadcast parameters 226 of the broadcast template 108. As an example, based on the reception data 228, UE 102 modifies a broadcast parameter 226 indicating a number of rebroadcasts for each packet of the broadcast series of packets representing audio signal 110 so as to help ensure each receiving device in the report group 222 (e.g., the first receiving device 112-1, the second receiving device 112-2, and the third receiving device 112-N) receives the packets representing audio signal 110. After UE 102 modifies one or more broadcast parameters 226 of the broadcast template 108 used to broadcast audio signal 110, UE 102 begins broadcasting audio signal 110 based on the updated broadcast template 108 (e.g., the broadcast template 108 with one or more modified broadcast parameters 226) represented in FIG. 6 as updated audio signal broadcast 630.

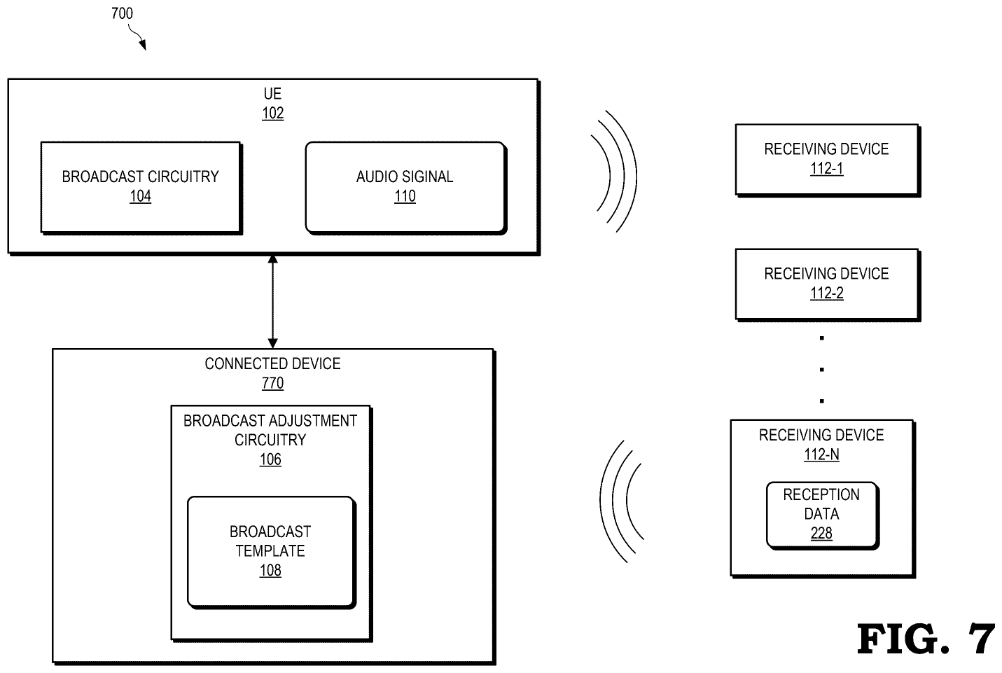

Referring now to FIG. 7, an example UE broadcast framework 700 including a connected device configured for reception-based broadcast template adjustment is presented. In some embodiments, example UE broadcast framework 700 includes UE 102 having broadcast circuitry 104 configured to broadcast audio signal 110 to one or more receiving devices 112. For example, broadcast circuitry 104 packetizes audio signal 110 into a series of packets and then broadcasts each packet of the series of packets to the receiving devices 112 according to one or more broadcast parameters 226 of a broadcast template 108. To help ensure that each receiving device 112 receives audio signal 110 without excessively draining a battery of UE 102, UE 102 is communicatively connected to connected device 770 including broadcast adjustment circuitry 106. For example, UE 102 is communicatively connected to connected device 770 via one or more wired communication protocols (e.g., Universal Serial Bus (USB) protocols, Thunderbolt protocols), wireless communication protocols (e.g., Bluetooth®, Bluetooth LE, ZigBee®, Wi-Fi, cellular protocols), or both. According to embodiments, connected device 770 includes a portable device (e.g., laptop computer, hotspot, tablet computer), wearable device (e.g., compute-enabled watch (“smartwatch), head-mounted display, fitness tracker, compute-enabled ring), or both.

According to embodiments, connected device 770 is configured to track reception data 228 from one or more receiving devices 112. To this end, connected device 770 includes broadcast adjustment circuitry 106 configured to first identify the receiving devices 112 within range of the broadcast of audio signal 110 by UE 102. For example, broadcast adjustment circuitry 106 is configured to first identify the receiving devices 112 within range of the broadcast of audio signal 110 by UE 102 based on one or more advertisement signals 117 broadcast by one or more receiving devices 112. After identifying the receiving devices 112 within range of the broadcast of audio signal 110 by UE 102, broadcast adjustment circuitry 106 then selects one or more of the identified receiving devices 112 to include in a report group 222. As an example, broadcast adjustment circuitry 106 selects one or more of the identified receiving devices 112 for inclusion in a report group 222 based on the types of the identified receiving devices 112 (e.g., wireless headphones, wireless earbuds, wireless in-ear monitors, wireless over-ear headphones, wireless on-ear headphones, bone-conduction headphones, wireless speakers, wireless hearing aids), one or more metrics of the receiving devices 112, operating modes of UE 200 (e.g., low-power mode, performance mode), metrics of UE 200, a random number generator, or any combination thereof.

Once broadcast adjustment circuitry 106 has added one or more of the identified receiving devices 112 to a report group 222, broadcast adjustment circuitry 106 is configured to track reception data 228 from each receiving device 112 within the report group 222. For example, based on one or more report triggers (e.g., a predetermined period of time elapsing, UE 102 changing locations, user inputs, one or more UE metrics reaching one or more predetermined thresholds) occurring, broadcast adjustment circuitry 106 is configured to poll or monitor for one or more advertisement signals 117 broadcast by one or more receiving devices 112 in the report group 222, send a report request (e.g., data requesting reception data 228) to one or more receiving devices 112 in the report group 222, or both. After polling or monitoring for one or more advertisement signals 117 broadcast by one or more receiving devices 112 in the report group 222 or sending a report request to one or more receiving devices 112 in the report group 222, broadcast adjustment circuitry 106 receives reception data 228 from the receiving devices 112 in the report group 222 as one or more advertisement signals 117, one or more report signals, or both. In response to receiving reception data 228 from one or more advertisement signals 117, report signals, or both, broadcast adjustment circuitry 106 saves the reception data 228 in a memory (e.g., memory 107) included in or otherwise connected to connected device 770, a database, or both as report group reception data 224.

According to embodiments, broadcast adjustment circuitry 106 is configured to, based on report group reception data 224, adjust one or more broadcast parameters 226 so as to indicate a number of rebroadcasts for each packet that helps ensure one or more certain receiving devices 112 in the report group 222 receive the packets of audio signal 110. That is to say, for example, based on the number of rebroadcasted packets received by the receiving devices 112 in a report group 222 over a predetermined period of time as indicated by report group reception data 224, broadcast adjustment circuitry 106 adjusts one or more broadcast parameters 226 of broadcast template 108 so as to indicate the minimum number of rebroadcasts for each packet necessary so as to have the likelihood that one or more certain receiving devices 112 in the report group 222 receive audio signal 110 be equal to or above a predetermined threshold. Once broadcast adjustment circuitry 106 adjusts one or more broadcast parameters 226 of broadcast template 108, data representing the broadcast parameters 226 are provided to UE 102. Broadcast circuitry 104 of UE 102 then broadcasts audio signal 110 to the receiving devices 112 based on the adjusted broadcast parameters 226 of the broadcast template 108. In this way, example UE broadcast framework 700 includes a connected device 770 communicatively coupled to UE 102 that is configured to adjust one or more broadcast parameters 226 of broadcast template 108 based on reception data 228 from the receiving devices 112.

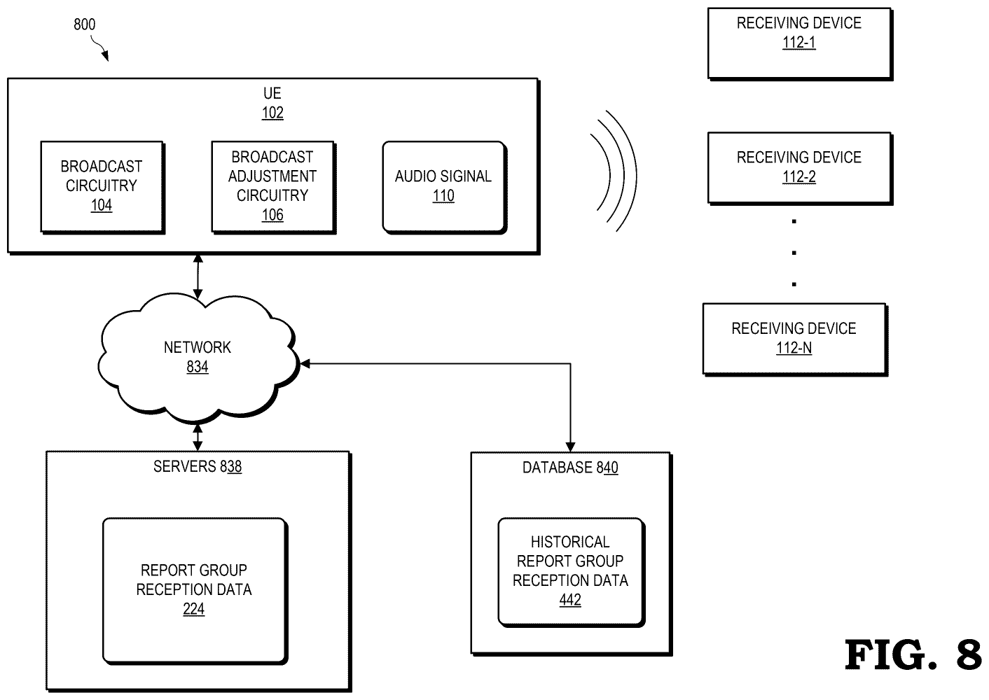

Referring now to FIG. 8, an example UE broadcast framework 800 including one or more servers configured for reception-based broadcast template adjustment is presented, in accordance with some embodiments. According to some embodiments, example UE broadcast framework 800 includes UE 102 having broadcast circuitry 108 configured to broadcast audio signal 110 to one or more receiving devices 112. For example, broadcast circuitry 104 packetizes audio signal 110 into a series of packets and then broadcasts each packet of the series of packets to the receiving devices 112 according to one or more broadcast parameters 226 of a broadcast template 108. To help ensure that each receiving device 112 receives audio signal 110 without excessively draining a battery of UE 102, UE 102 is communicatively connected to one or more servers 838 configured to perform one or more determinations, functions, operations, or any combination thereof on behalf of broadcast adjustment circuitry 106 of UE 102. As an example, one or more servers 838 are configured to adjust one or more broadcast parameters 226 of broadcast template 108 based on data (e.g., report group reception data 224) broadcast adjustment circuitry 106 receives from one or more receiving devices 112. In embodiments, UE 102 is communicatively connected to such servers 838 via a network 834. The network 834, for example, includes a local area network, wide area network, cellular network, or any combination thereof.

According to embodiments, one or more servers 838 are configured to track reception data 228 from one or more receiving devices 112. To this end, UE 102 includes broadcast adjustment circuitry 106 configured to first identify the receiving devices 112 within range of the broadcast of audio signal 110 by UE 102. For example, in embodiments, UE 102 is configured to poll or monitor for and receive one or more advertisement signals 117 from one or more receiving devices 112. UE 102 then provides data representing these advertisement signals 117 to servers 838 via network 834. According to some embodiments, based on the data representing the advertisement signals 117, one or more servers 838 then identify the receiving devices 112 within range of the broadcast of audio signal 110 by UE 102. After identifying the receiving devices 112 within range of the broadcast of audio signal 110 by UE 102, one or more servers 838 select one or more of the identified receiving devices 112 to include in a report group 222. As an example, one or more servers 838 select one or more of the identified receiving devices 112 for inclusion in a report group 222 based on the types of the identified receiving devices 112 (e.g., wireless headphones, wireless earbuds, wireless in-ear monitors, wireless over-ear headphones, wireless on-ear headphones, bone-conduction headphones, wireless speakers, wireless hearing aids), one or more metrics of the receiving devices 112, operating modes of UE 200 (e.g., power-saving mode, performance mode), metrics of UE 102, a random number generator, or any combination thereof.

Once one or more servers 838 have added one or more of the identified receiving devices 112 to a report group 222, data representing the report group 222 is then transmitted back to UE 102 via network 834. Based on the data representing the report group 222, broadcast adjustment circuitry 106 of UE 102 is configured to track reception data 228 from each receiving device 112 within the report group 222. For example, based on one or more report triggers (e.g., a predetermined period of time elapsing, UE 102 changing locations, user inputs, one or more UE metrics reaching one or more predetermined thresholds) occurring, UE 102 is configured to poll or monitor for one or more advertisement signals 117 broadcast by one or more receiving devices 112 in the report group 222, send a report request (e.g., data requesting reception data 228) to one or more receiving devices 112 in the report group 222, or both. After polling or monitoring for one or more advertisement signals 117 broadcast by one or more receiving devices 112 in the report group 222 or sending a report request to one or more receiving devices 112 in the report group 222, UE 102 receives reception data 228 from the receiving devices 112 in the report group 222 as one or more advertisement signals 117, one or more report signals, or both. UE 102 then sends data representing the reception data (e.g., 228-1, 228-2, 228-N) from the receiving devices 112 in the report group 222 to one or more servers 838 via network 834. In response to receiving the data representing the reception data 228 from one or more advertisement signals 117, report signals, or both, one or more servers 838 then save the reception data 228 in a memory (e.g., memory 103) included in or otherwise connected to one or more servers 838, a database 840, or both as report group reception data 224. Further, in embodiments, the database 840 is configured to store group reception data from one or more UEs 102 as historical report group reception data 882. Such historical report group reception data 882, for example, includes previous reception data 228 from one or more receiving devices received by one or more UEs 102, broadcast adjustment circuitries 106, or both.

According to embodiments, one or more servers 838 are configured to, based on report group reception data 224, historical report group reception data 882, or both, adjust one or more broadcast parameters 226 so as to indicate a number of rebroadcasts for each packet that helps ensure one or more certain receiving devices 112 in the report group 222 receive the packets of audio signal 110. That is to say, based on the number of rebroadcasted packets received by the receiving devices 112 in a report group 222 over a predetermined period of time as indicated by report group reception data 224, historical report group reception data 882, or both, one or more servers 838 adjust one or more broadcast parameters 226 so as to indicate the minimum number of rebroadcasts for each packet necessary so as to have the likelihood that one or more certain receiving devices 112 in the report group 222 receive audio signal 110 be equal to or above a predetermined threshold. The servers 838 then transmit data representing the updated broadcast parameters 226 to UE 102 via network 834. Based on receiving data representing the updated broadcast parameters 226, broadcast adjustment circuitry 106 updates a broadcast template 108 to reflect the updated broadcast parameters 226. Broadcast circuitry 104 then broadcasts audio signal 110 based on the updated broadcast template 108.

In some embodiments, one or more servers 838 are configured to train one or more machine learning models, neural networks, or both using historical report group reception data 882, report group reception data 224, or both. By training the machine learning models, neural networks, or both using historical report group reception data 882, report group reception data 224, or both, the servers 838 generate one or more trained machine learning models, neural networks, or both configured to receive at least a portion of report group reception data 224 as an input and output one or more broadcast parameters 226 that help ensure reception of audio signal 110 by receiving devices 112. In this way, example UE broadcast framework 800 includes servers 838 communicatively coupled to UE 102 via network 834 that are configured to adjust one or more broadcast parameters 226 of broadcast template 108 based on reception data 228 from the receiving devices 112, historical report group reception data 882, or both.

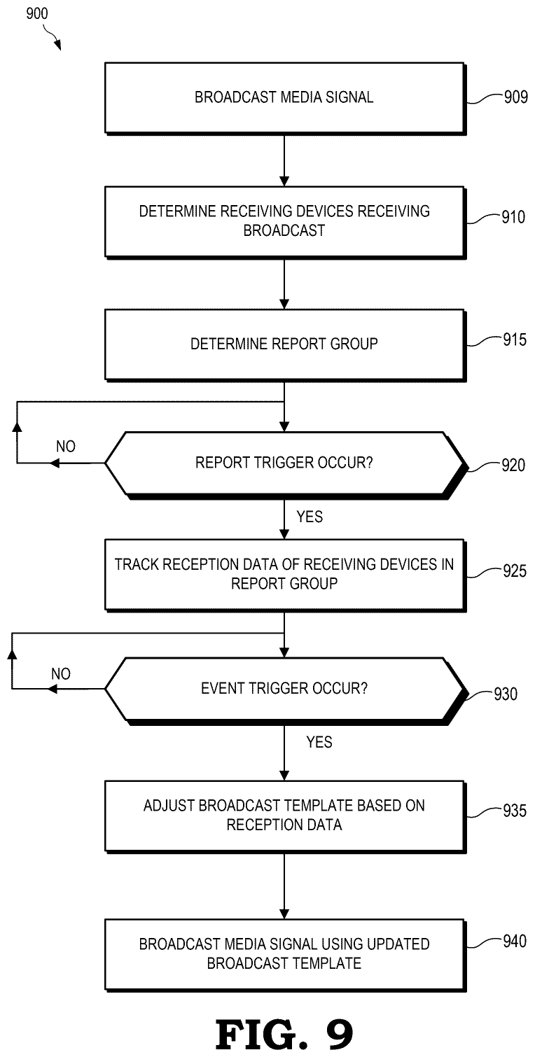

Referring now to FIG. 9, an example method 900 for adjusting a broadcast template based on reception data from one or more receiving devices, in accordance with some embodiments. In embodiments, example method 900 is implemented within UE broadcast frameworks 100, 700, 800. According to embodiments, at block 905 of example method 900, broadcast circuitry 104 of UE 102 broadcasts audio signal 110 to one or more receiving devices 112. For example, broadcast circuitry 104 packetizes audio signal 110 into a series of packets and then broadcasts each packet of the series of packets to the receiving devices 112 according to one or more broadcast parameters 226 of a broadcast template 108. In embodiments, broadcast circuitry 104 is configured to broadcast each packet of audio signal 110 on a first broadcast channel 105. To help ensure the packets of audio signal 110 are received by the receiving devices 112, broadcast circuitry 104 is configured to rebroadcast each packet of audio signal 110 a predetermined number of times as indicated by broadcast template 108. As an example, broadcast circuitry 104 rebroadcasts each packet of audio signal 110 a predetermined number of times on a broadcast channel 105 different from the broadcast channel 105 used to originally broadcast the packet. At block 910, broadcast adjustment circuitry 106 included in or otherwise connected to UE 102 identifies one or more receiving devices 112 within range of the broadcast of audio signal 110 by broadcast circuitry 104. For example, in embodiments, at block 910, UE 102, broadcast adjustment circuitry 106, or both is configured to monitor for and receive one or more advertisement signals 117 from one or more receiving devices 112. Based on the advertisement signals 117, broadcast adjustment circuitry 106 identifies the receiving devices 112 within range of the broadcast of audio signal 110 by broadcast circuitry 104.

After identifying the receiving devices 112 within range of the broadcast of audio signal 110 by UE 102, at block 915, broadcast adjustment circuitry 106 is configured to select one or more of the identified receiving devices 112 to include in a report group 222. As an example, broadcast adjustment circuitry 106 selects one or more of the identified receiving devices 112 for inclusion in a report group 222 based on the types of the identified receiving devices 112 (e.g., wireless headphones, wireless earbuds, wireless in-ear monitors, wireless over-ear headphones, wireless on-ear headphones, bone-conduction headphones, wireless speakers, wireless hearing aids), one or more metrics of the receiving devices 112, operating modes of UE 102 (e.g., power-saving mode, performance mode), metrics of UE 102, a random number generator, or any combination thereof. Metrics of a receiving device 112 include, for example, the distance of the receiving device 112 from UE 102, the battery level of the receiving device 112, an operating mode of the receiving device 112 (e.g., power-saving mode, performance mode), settings of the receiving device 112 (e.g., power-saving settings, performance mode settings, audio quality settings), user inputs, or any combination thereof. Metrics of UE 102, for example, include a battery level of UE 102, temperature of UE 102, settings of UE 102 (e.g., lower-power settings, performance mode settings, audio quality settings), or any combination thereof. For example, still referring to block 915, based on UE 102 being in a performance operating mode, broadcast adjustment circuitry 106 is configured to select a predetermined number of the identified receiving devices farthest from the user to be in the report group 222. As another example, based on UE 102 being in a low-power operating mode, broadcast adjustment circuitry 106 is configured to select a predetermined number of the identified receiving devices closest from the user to be in the report group 222. As yet another example, broadcast adjustment circuitry 106 is configured to randomly select a predetermined number of the identified receiving devices to be in the report group 222.

Once broadcast adjustment circuitry 106 has selected one or more identified receiving devices 112 to be in the report group 222, at block 920, broadcast adjustment circuitry 106 determines whether one or more report triggers have occurred. Such report triggers, for example, include a predetermined period of time elapsing (e.g., a predetermined period of time since forming a report group 222 elapsing), UE 102 changing locations, user inputs, one or more UE metrics (e.g., battery level, temperature) reaching one or more predetermined thresholds, or any combination thereof. Based on broadcast adjustment circuitry 106 determining a report trigger has not occurred, broadcast adjustment circuitry 106 repeats block 920 until a report trigger does occur. Based on broadcast adjustment circuitry 106 determining a report trigger has occurred, broadcast adjustment circuitry 106 moves to block 925. At block 925, broadcast adjustment circuitry 106 tracks the reception data 228 of each receiving device 112 in the report group 222. To this end, UE 102, broadcast adjustment circuitry 106, or both are configured to poll or monitor for one or more advertisement signals 117 (e.g., advertisement signals including reception data 228) broadcast by one or more receiving devices 112 in the report group, send a report request (e.g., data requesting reception data 228) to one or more receiving devices 112 in the report group, or both. After receiving the reception data 228 from the receiving devices 112 in the report group 222 as one or more advertisement signals 117, report signals, or both, broadcast adjustment circuitry 106 stores the reception data in a memory (e.g., memory 103), a database (e.g., database 440), or both as report group reception data 224, historical report group reception data 442, or both.

After storing the received reception data 228, at block 930, broadcast adjustment circuitry 106 determines whether one or more trigger events 225 have occurred. Such trigger events 225, for example, include a predetermined period of time elapsing (e.g., a predetermined period of time since UE 102 began broadcasting audio signal 110, a predetermined period of time since a previous trigger event 225), UE 102 changing locations, user inputs, one or more UE metrics (e.g., battery level, temperature) reaching one or more predetermined thresholds, or any combination thereof. Based on determining that no trigger events 225 have occurred, broadcast adjustment circuitry 106 repeats block 930 until a trigger event 225 occurs. Based on determining that a trigger event 225 has occurred, broadcast adjustment circuitry 106 moves to block 935. At block 935, broadcast adjustment circuitry 106 adjusts the broadcast template 108 used to broadcast audio signal 110 based on the reception data 228 received from the receiving devices 112 in the report group 222. That is to say, broadcast adjustment circuitry 106 adjusts one or more broadcast parameters 226 based on report group reception data 224, historical report group reception data 442, or both. As an example, based on the number of rebroadcasted packets received by the receiving devices 112 in a report group 222 over a predetermined period of time as indicated by report group reception data 224, broadcast adjustment circuitry 106 adjusts one or more broadcast parameters 226 so as to indicate the minimum number of rebroadcasts for each packet necessary so as to have the likelihood that one or more certain receiving devices 112 in the report group 222 receive audio signal 110 be equal to or above a predetermined threshold. At block 940, broadcast circuitry 104 broadcasts audio signal 110 based on the updated broadcast template 108. That is to say, broadcast circuitry 104 broadcasts audio signal 110 based on the broadcast parameters 226 modified at block 935. In this way, broadcast adjustment circuitry 106 is configured to adjust the broadcast of audio signal 110 to the receiving devices 112 based on the reception data 228 of the receiving devices 112 whenever a trigger event 225 occurs.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
concurrently broadcasting, by a user equipment (UE), an audio signal to a plurality of receiving devices based on one or more broadcast parameters;
based on an event trigger occurring, adjusting the one or more broadcast parameters based on reception data received from one or more receiving devices of the plurality of receiving devices; and
broadcasting the audio signal based on the adjusted one or more broadcast parameters.

2. The method of claim 1, wherein the audio signal is concurrently broadcasted to the plurality of receiving devices by a unidirectional channel using Bluetooth Low Energy protocols.

3. The method of claim 1, further comprising:
monitoring for an advertisement signal broadcast by a receiving device of the plurality of receiving devices, wherein the advertisement signal indicates a portion of the reception data associated with the receiving device of the plurality of receiving devices.

4. The method of claim 1, further comprising:
concurrently with broadcasting the audio signal to the plurality of receiving devices, requesting reception data from a receiving device of the plurality of receiving devices.

5. The method of claim 1, wherein adjusting the one or more broadcast parameters includes adjusting a number of times to rebroadcast each packet of the audio signal.

6. The method of claim 1, wherein the one or more receiving devices includes a predetermined number of receiving devices of the plurality of receiving devices closest in distance to the UE.

7. The method of claim 1, wherein the reception data indicates a respective number of packets of the audio signal received by each receiving device of the one or more receiving devices.

8. A system comprising:
a user equipment (UE) configured to concurrently broadcast an audio signal to a plurality of receiving devices based on one or more broadcast parameters; and
a broadcast adjustment circuitry configured to, based on an event trigger occurring, adjust the one or more broadcast parameters based on reception data received from one or more receiving devices of the plurality of receiving devices,
wherein the UE is configured to broadcast the audio signal based on the adjusted one or more broadcast parameters.

9. The system of claim 8, wherein the broadcast adjustment circuitry is implemented in a wearable device communicatively coupled to the UE.

10. The system of claim 8, wherein the UE is configured to concurrently broadcast the audio signal to the plurality of receiving devices by a unidirectional channel using Bluetooth Low Energy protocols.

11. The system of claim 8, wherein the broadcast adjustment circuitry is configured to:
monitor for an advertisement signal broadcast by a receiving device of the plurality of receiving devices, wherein the advertisement signal indicates a portion of the reception data associated with the receiving device of the plurality of receiving devices.

12. The system of claim 8, wherein the broadcast adjustment circuitry is configured to:
concurrently with the UE broadcasting the audio signal to the plurality of receiving devices, request reception data from a receiving device of the plurality of receiving devices.

13. The system of claim 8, wherein adjusting the one or more broadcast parameters includes adjusting a number of times to rebroadcast each packet of the audio signal.

14. The system of claim 8, wherein the one or more receiving devices includes a predetermined number of receiving devices of the plurality of receiving devices farthest in distance from the UE.

15. The system of claim 8, wherein the reception data indicates a respective number of packets of the audio signal received by each receiving device of the one or more receiving devices.

16. A method, including:
broadcasting, by a user equipment (UE), a series of packets representing an audio signal to a plurality of receiving devices, wherein broadcasting the series of packets includes rebroadcasting each packet of the series of packets to the plurality of receiving devices based on one or more broadcast parameters;
forming a report group including one or more receiving devices of the plurality of receiving devices;
adjusting the one or more broadcast parameters based on reception data received from the report group; and
broadcasting the audio signal to the plurality of receiving devices based on the adjusted one or more broadcast parameters.

17. The method of claim 16, wherein each packet of the series of packets representing the audio signal is broadcast on a first unidirectional channel using Bluetooth Low Energy protocols.

18. The method of claim 16, further comprising:
based on a report trigger occurring, monitoring for an advertisement signal broadcast by a receiving device of the report group, wherein the advertisement signal indicates reception data associated with the receiving device of the plurality of receiving devices.

19. The method of claim 16, further comprising:
based on a report trigger occurring, sending a signal to a receiving device of the report group requesting reception data associated with the receiving device.

20. The method of claim 16, wherein forming the report group includes selecting one or more receiving devices of the plurality of receiving devices based on their respective distances from the UE.
